(19) United States
(12) Patent Application Publication
(10) Pub. No.: US 2013/0010334 A1
(43) Pub. Date: Jan. 10, 2013

(54) IMAGE FORMING APPARATUS AND IMAGE FORMING SYSTEM

(76) Inventor: Katsuya AKIBA, Ibaraki (JP)

(21) Appl. No.: 13/426,017

(22) Filed: Mar. 21, 2012

(30) Foreign Application Priority Data
Jul. 7, 2011 (JP) 2011-150843

(51) Int. Cl. G06K 15/02

(52) U.S. Cl. 358/1.16

(57) ABSTRACT

An image forming apparatus includes: a print data storing unit that stores therein input print data; a delay-time input unit that inputs delay time for receiving a print of the print data; a controlling unit that controls start timing of printing by referring to the delay time for receiving the print that has been input from the delay-time input unit, actual time, and a printing state; and a printing unit that converts the print data stored in the print data storing unit into printing image data suitable for printing and starts printing.

### CROSS-REFERENCE TO RELATED APPLICATIONS

The present application claims priority to and incorporates by reference the entire contents of Japanese Patent Application No. 2011-150843 filed in Japan on Jul. 7, 2011. The present document incorporates by reference the entire contents of Japanese Patent Application No. 2011-049093 filed in Japan on Mar. 7, 2011.

### BACKGROUND OF THE INVENTION

1. Field of the Invention

The present invention relates to an image forming apparatus such as a copying machine or a printer, more specifically, to a shared image forming apparatus that is used in an office or the like by being connected to a network; and an image forming system implemented therein.

2. Description of the Related Art

It is widely known that frequent starting up and shutting down operations of a printer engine unit in response to asynchronous print requests from a plurality of users cause an increase in power load or reduction in the lifetime of consumables of a shared image forming apparatus connected to a network in an office or the like. Accordingly, with respect to print matters having restriction in time, there has also been known a technique for specifying delayable time in advance and causing the image forming apparatus to print the matters according to a printing schedule based on the delayable time, thus reducing the power load and prolonging the lifetime of the consumables.

Furthermore, Japanese Patent Application Laid-open No. 2010-096934 discloses, with the view of improving productivity by reducing printing waiting time while preventing the reduction in the lifetime of the image forming apparatus, a method for reducing the number of useless starting up operations of the printer engine unit by making a comparison between a time period needed for processing a print request and allowable printing delay time that has been preset.

In the conventional image forming apparatus, when the delayable time is specified in advance to reduce the power load and prolong the lifetime of the consumables of the apparatus, in order to obtain the printing time, it is necessary to correctly perceive a state of the image forming apparatus such as image-processing time or time for switching mechanical portions therein so as to schedule print data at any time. Hence, especially in the image forming system configured by connecting a plurality of post processing devices therewith, it has been difficult to calculate the printing time.

Furthermore, even when the delayable time for printing is specified, the next print request causes the printer engine unit to perform a starting-up operation and to start printing. Due to these, there has been a drawback that the reduction in the power load or the prolongation of the lifetime of the consumables remains insufficient.

Furthermore, with the image forming apparatus described in Japanese Patent Application Laid-open No. 2010-096934, a problem in the insufficiency for reducing the number of the starting up operations of the printer engine unit remains unsolved.

Thus, there is a need to provide an image forming apparatus and an image forming system that perform printing processes in a lump in accordance with asynchronous print requests from a plurality of users connected to the system within time allowable for the users by setting allowable delay time for receiving the print requests, whereby the starting up operations and shutting down operations of the printer engine unit can be consolidated, the power load of the apparatus can be reduced, and the lifetime of consumables thereof can be prolonged.

### SUMMARY OF THE INVENTION

It is an object of the present invention to at least partially solve the problems in the conventional technology.

An image forming apparatus includes: a print data storing unit that stores therein input print data; a delay-time input unit that inputs delay time for receiving a print of the print data; a controlling unit that controls start timing of printing by referring to the delay time for receiving the print that has been input from the delay-time input unit, actual time, and a printing state; and a printing unit that converts the print data stored in the print data storing unit into printing image data suitable for printing and starts printing.

An image forming system includes: an image forming apparatus that includes: a print data storing unit that stores therein input print data; a controlling unit that controls start timing of printing by referring to delay time for receiving a print, actual time, and a printing state; and a printing unit that converts the print data stored in the print data storing unit into printing image data suitable for printing and starts printing; and an external information processing device connected to the image controlling apparatus. The delay time for receiving the print is inputtable together with the print data to the image forming apparatus from the external information processing device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an overall configuration of an image forming apparatus according to an embodiment;

FIG. 2 is a schematic diagram of an image forming system that includes the image forming apparatus according to the embodiment;

FIG. 3 is a block diagram illustrating a configuration of a printer controller of the image forming apparatus according to the embodiment;

FIG. 4 is a flowchart for explaining a process operation of the printer controller of the image forming apparatus according to the embodiment;

FIGS. 5A and 5B are timing charts for explaining scheduled operation start time of the printer engine unit in the image forming apparatus according to the embodiment, FIG. 5A is the timing chart when a delay time for receiving a print request is set only in the printer body, and FIG. 5B is the timing chart when the delay time for receiving the print request is set by each printer user (printer driver); and

FIG. 6 is a schematic diagram illustrating an overall structure of an image forming apparatus according to another embodiment.

### DETAILED DESCRIPTION OF THE PREFERRED EMBODIMENTS

An embodiment is described below with respect to a printing operation instructed to a printer engine unit from a printer controller of an image forming apparatus.

That is, the present embodiment includes a function to reduce an operation frequency of the printer engine unit as follows. First, information of an allowable delay time for receiving a print request is preset in print data or the image forming apparatus, and second, the printer controller determines an operating state of the printer engine unit when the image forming apparatus receives the print data. Third, when the printer engine unit is in a standby state, the printer controller compares the allowable delay time for receiving the print request of the received print data with the allowable delay time for receiving the print request in the print data stored in the image forming apparatus. Then, if the delay time for receiving the print request is within an allowable range of the delay, the printer engine unit is not operated and a print request is held in the image forming apparatus.

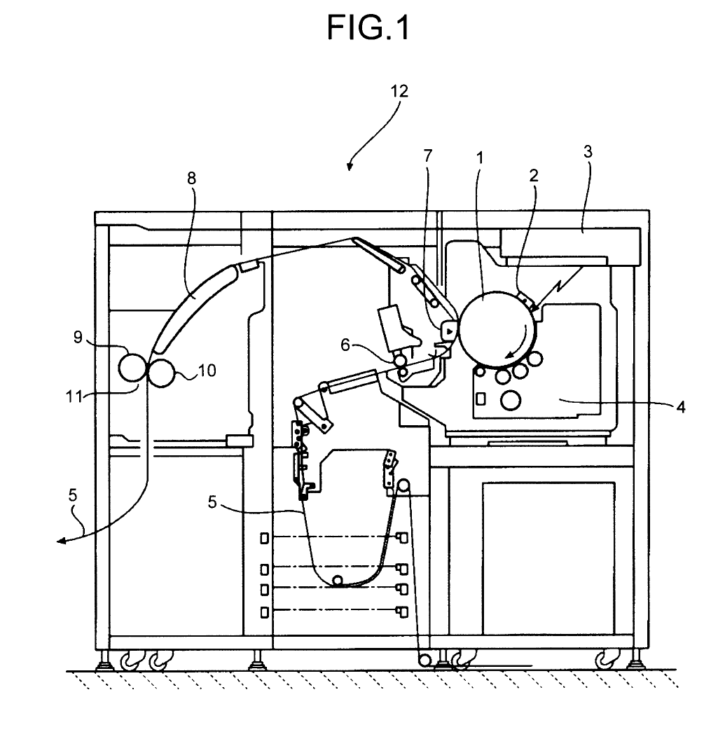

Next, the present embodiment is explained in conjunction with the drawings. FIG. 1 is a schematic diagram illustrating the overall structure of the image forming apparatus according to the present embodiment.

First, a charging unit 2 applies charge to an outer circumferential surface of a photosensitive element 1. Next, an exposure pattern based on the print data is projected onto the outer circumferential surface of the charged photosensitive element 1 by an exposing unit 3, so that an electrostatic latent image is formed on the photosensitive element 1. The electrostatic latent image on the photosensitive element 1 is developed by a developing unit 4 to form a toner image on the photosensitive element 1.

Continuous-form paper is used for a web 5. The web 5 is conveyed to a position between the photosensitive element 1 and a transfer unit 7 by a web conveying unit 6, and the toner image on the photosensitive element 1 is transferred onto the web 5 by the transfer unit 7. The web 5 that carries the toner image is preheated by a preheater 8 whereby the toner image is fused and fixed onto the web 5 by a fixing unit 11 formed by a heating roller 9 including a heater and a pressing roller 10. The web 5 on which the image is formed as described above is discharged from an image forming apparatus 12 and fed into a following post-processing device (not illustrated in the drawings).

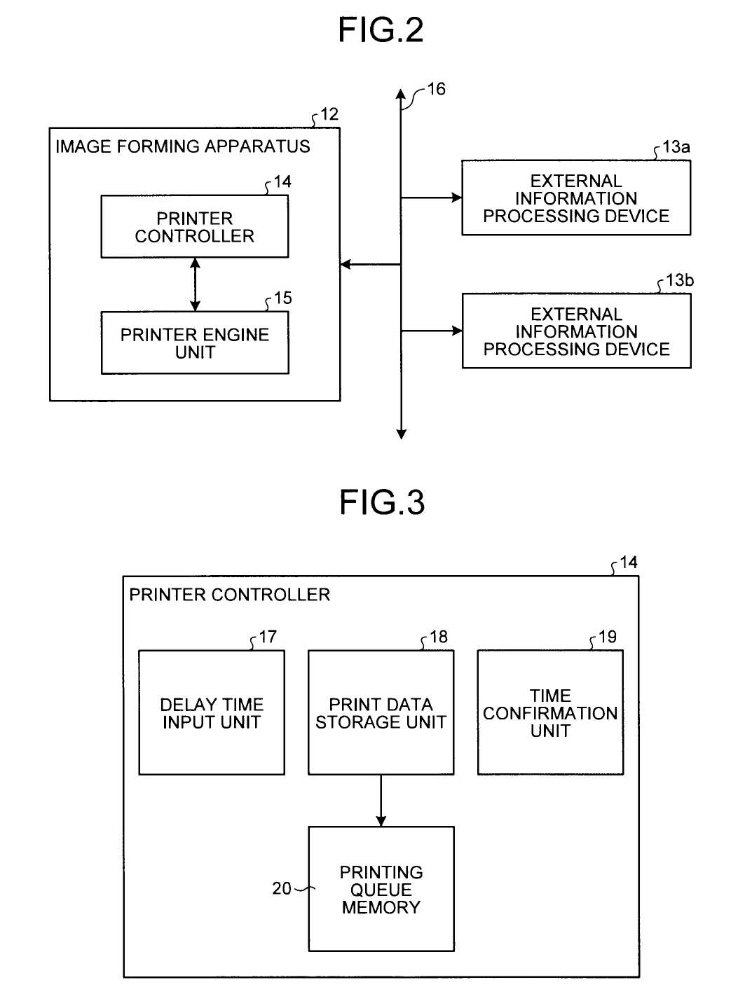

FIG. 2 is a schematic diagram of an image forming system that includes the image forming apparatus 12.

As illustrated in FIG. 2, the image forming apparatus 12 mainly includes a printer controller 14 that controls the entire apparatus and receives data from a plurality of external information processing devices 13a, 13b . . . ; and a printer engine unit 15 that performs a printing operation. The printer controller 14 is configured by a CPU (not illustrated in the drawings) included in the image forming apparatus 12. Furthermore, the printer engine unit 15 includes the photosensitive element 1, the charging unit 2, the exposing unit 3, the developing unit 4, the web conveying unit 6, the transfer unit 7, the fixing unit 11, and the like illustrated in FIG. 1.

The external information processing devices 13a, 13b . . . are connected to the image forming apparatus 12 via a general-purpose interface cable such as a USB connection cable or a network 16 by TCP/IP protocol, etc. Each one of the external information processing devices 13a, 13b . . . , which is denoted by a device 13 below for abbreviation, is, for example, a terminal device such as a personal computer, and the user operates a device driver (not illustrated in the drawings) to convert a document or an image into print data written in a printable language and causes the terminal device to transmit the print data to the image forming apparatus 12. Therefore, the image forming apparatus 12 is shared by a plurality of users who own the external information processing devices 13a, 13b . . . , and starting up operations and shutting down operations of the printer engine unit 15 are frequently performed by asynchronous print requests from the users.

FIG. 3 is a block diagram illustrating the configuration of the printer controller 14.

As illustrated in FIG. 3, the printer controller 14 includes a delay-time input unit 17 for inputting allowable delay time for receiving the print request, a print data storing unit 18, a time confirmation unit 19, and a printing queue memory 20. Here, the delay-time input unit 17 may be an operation panel provided on the image forming apparatus 12, the print data storing unit 18 may be a hard disk that stores therein the print data transmitted from the external information processing devices 13a, 13b . . . , and the time confirmation unit 19 may be a clock.

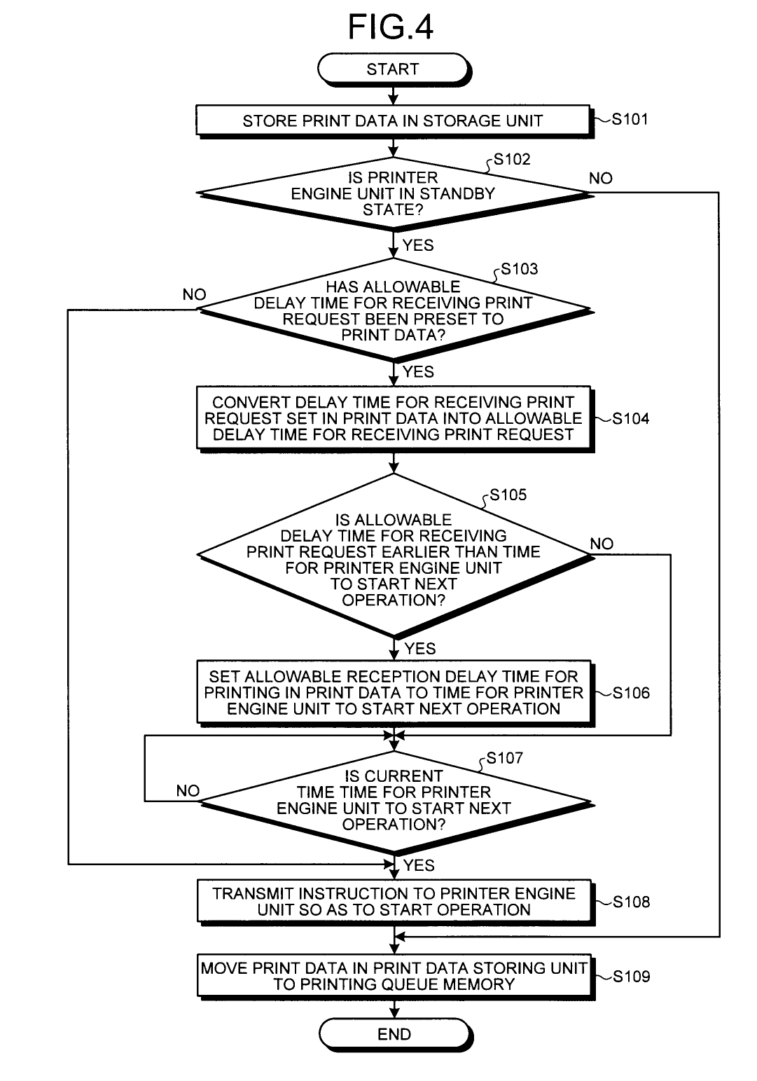

When the image forming apparatus 12 receives the print data transmitted from the external information processing device 13, the image forming apparatus 12 performs a processing flow illustrated in FIG. 4. Next, the processing flow is explained.

Step S101: when the printer controller 14 receives the print data transmitted from the external information processing device 13, the print data is stored in the print data storing unit 18, and the process sequence proceeds to Step S102 which is the next step.

Step S102: next, determination is made on whether or not the printer engine unit 15 is in a standby state. If the printer engine unit 15 is not in a standby state but in operation (NO at Step S102), the process sequence proceeds to Step S109. In contrast, if the printer engine unit 15 is in a standby state (YES at Step S102), the process sequence proceeds to Step S103.

Step S103: the delay-time input unit (operation panel) 17 determines whether or not the delay time for receiving the print request has been preset when the print data is received. If the delay time for receiving the print request has not been set (NO at Step S103), the process sequence proceeds to Step S108. If the delay time for receiving the print request has been set (YES at Step S103), the process sequence proceeds to Step S104.

Step S104: the delay time for receiving the print request that has been set is converted into the allowable delay time for receiving the print request with the time confirmation unit (clock) 19. For example, assuming that the delay time for receiving the print request having been set is 10 minutes and the current time is 10:40 a.m., the allowable delay time for receiving the print request becomes 10:50 a.m.

Step S105: the allowable delay time for receiving the print request obtained by the conversion at Step S104 is compared with time for the printer engine unit 15 to start the next operation. If the delay time for receiving the print request is later than the time for the printer engine unit 15 to start the next operation (NO at Step S105), the process sequence proceeds to Step S107. On the contrary, if the delay time for receiving the print request is earlier than the time for the printer engine unit 15 to start the next operation (YES at Step S105), the process sequence proceeds to Step S106 that follows.

Step S106: the allowable delay time for receiving the print request in the print data is changed to the time for the printer engine unit 15 to start the next operation. Thus, the operation of the printer engine unit 15 can be started earlier.

Step S107: if there is no request for further earlier allowable delay time for receiving the print request, the clock monitors the current time. When the current time reaches time when the printer engine unit 15 starts the next operation, the process sequence proceeds to Step S108.

Step S108: when the current time reaches the time when the printer engine unit 15 starts the next operation, the printer controller 14 issues an instruction for starting the operation to the printer engine unit 15.

Step S109: the print data stored in the print data storing unit 18 is moved to the printing queue memory 20, where the moved print data is converted to image data and sequentially transmitted to the printer engine unit 15 to be printed.

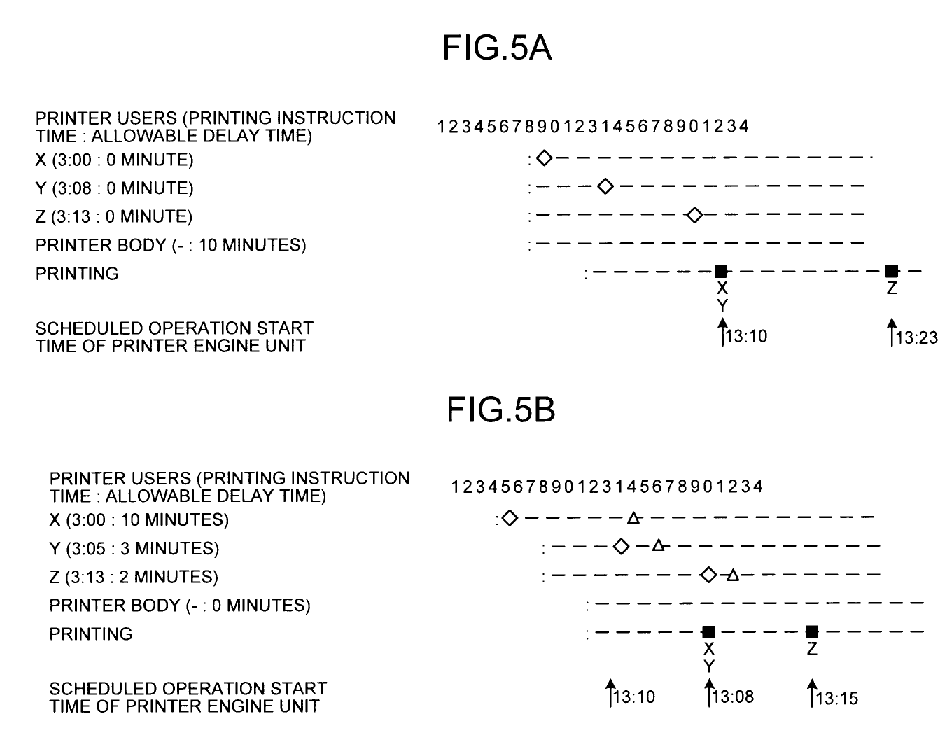

FIGS. 5A and 5B are the timing charts for explaining scheduled operation start time of the printer engine unit 15. FIG. 5A is the timing chart in the case where the delay time for receiving the print request is set only in the printer body. FIG. 5B is the timing chart in the case where each of the printer users (printer drivers) sets the delay time for receiving the print request.

First, the timing chart in the case where the delay time for receiving the print request is set only in the printer body is described with reference to FIG. 5A.

As illustrated in FIG. 5A, there is a plurality of printer users (printer drivers) X, Y, and Z. Assuming that allowable delay time for receiving a print request set in the printer body is 10 minutes and there is no job waiting to be printed, when the user X issues a first print request at 3:00, the user Y issues a second print request 5 minutes later, and the user Z issues a third print request 8 minutes further later, the allowable waiting time for printing of the first print request issued by the user X is 3:10. The allowable waiting time for printing of the second print request having been issued by the user Y 5 minutes later than the first print request issued by the user X is 3:15. At 3:10, the printing operation is started, and printing jobs due to the first and second printing requests, which have been in a standby state at this time, of the user X and the user Y, respectively, are started.

Next, the timing chart in the case where each of the printer users (printer drivers) sets the delay time for receiving the print request is explained with reference to FIG. 5B.

As illustrated in FIG. 5B, there is a plurality of printer users (printer drivers) X, Y, and Z. Suppose that the allowable delay time for receiving a print request set by the printer users X, Y, and Z are 10 minutes, 3 minutes, and 2 minutes, respectively, and there is no job waiting to be printed. Then, if the user X issues a first print request at 3:00, the user Y issues a second print request 5 minutes later, and the user Z issues a third print request 8 minutes further later, the maximum allowable waiting time for printing of the first print request by the user X is 3:10. However, when the second print request by the user Y whose maximum allowable printing standby time is 3 minutes is issued at 3:05, the next start time for printing is changed to 3:08. At 3:08, the second printing job of the user Y is started and, at the same time, the first printing job of the user X is also started.

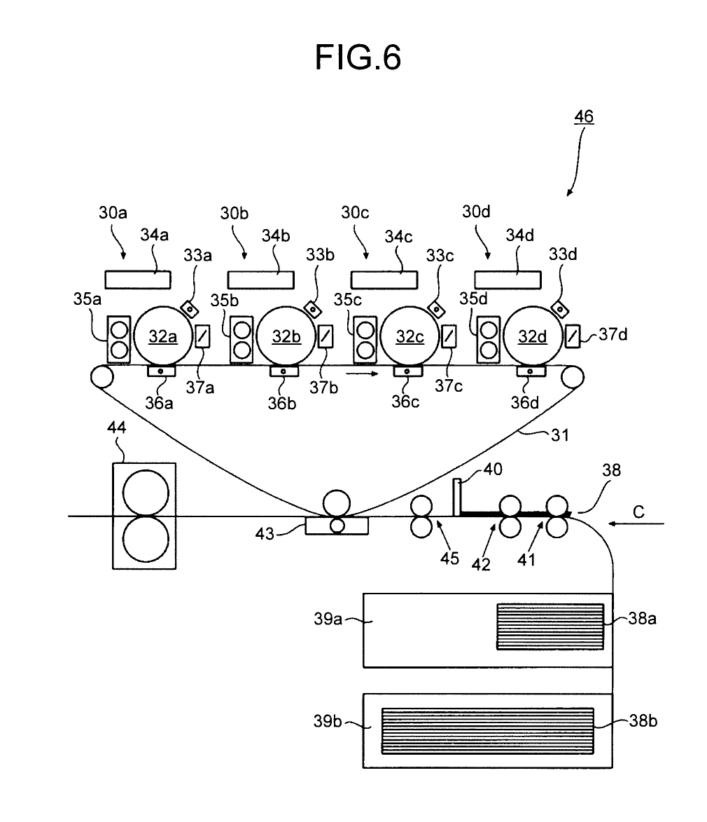

FIG. 6 is a schematic diagram illustrating the overall structure of the image forming apparatus according to the other embodiment. With an image forming apparatus 46 in the other embodiment, a full-color image in four colors of yellow, magenta, cyan, and black can be formed.

As illustrated in FIG. 6, image forming units 30 (30a, 30b, 30c, and 30d) for the four colors are arranged along a travelling direction (direction indicated by an arrow) of a transfer belt 31.

Each image forming unit 30 (30a to 30d) includes a photosensitive element 32 (32a to 32d) as an image carrier, a photosensitive-element charging unit 33 (33a to 33d), an exposing unit 34 (34a to 34d), a developing unit 35 (35a to 35d), an intermediate transfer unit 36 (36a to 36d), and a cleaning device 37 (37a to 37d) that are disposed at predetermined positions. The procedures for forming toner images by the respective elements are substantially the same as those of the above-mentioned embodiment and the explanations thereof are omitted.

The image forming units 30 (30a to 30d) form the toner images in the four colors of yellow, magenta, cyan, and black on the respective photosensitive elements 32 (32a to 32d). The toner images are transferred onto the transfer belt 31 in a superimposed manner by the intermediate transfer units 36 (36a to 36d), and thus a full-colored toner image in the four colors is formed.

Meanwhile, recording media 38 are housed in a plurality of paper feed trays 39a and 39b arranged in a stacked manner according to the size thereof. The recording medium 38 is fed from a selected one of the paper feed trays 39a and 39b onto a conveying path and a leading end thereof abuts on a gate unit 40. While abutting the leading end of the recording medium 38 on the gate unit 40, a trailing end side of the recording medium 38 is conveyed toward the gate unit 40 side by a pair of carriage rollers 41, and hence, the recording medium 38 is excessively conveyed, so that a deflection is formed thereon.

An oblique deviation of the leading end portion of the recording medium 38 is corrected by the excessive feeding of the recording medium 38 in a state where the leading end of the recording medium 38 abuts on the gate unit 40 as described above. In such a state, a pair of registration rollers 42 is used to sandwich the recording medium 38, and thus the leading end portion of the recording medium 38 is positioned at a position of the gate unit 40.

Next, the gate unit 40 is opened in such a manner that the gate unit 40 is retracted from the conveying path. Furthermore, members of the pair of carriage rollers 41 are separated from each other and hence, the recording medium 38 is returned to a state without deflection. That is, the positional deviation of the recording medium 38 on the upstream side of the pair of registration rollers 42 in the conveying direction is also corrected.

Here, in accordance with the timing of the toner image carried by the transfer belt 31, the pair of registration rollers 42 start to convey the recording medium 38 in a direction indicated by arrow C at a predetermined timing that is the timing at which the position of the leading end of the toner image on the transfer belt 31 in the belt travelling direction coincides with a predetermined position of the leading end portion of the recording medium 38 in the conveying direction.

Furthermore, when the full-color toner image formed on the transfer belt 31 reaches a final transfer unit 43, the toner image is transferred onto the recording medium 38 due to high voltage applied to the final transfer unit 43.

The full-color toner image transferred onto the recording medium 38 is heated and pressed while passing through a fixing unit 44 and is fixed onto the recording medium 38.

Here, the reference numerals 38a and 38b in FIG. 6 denote the recording media housed in the paper feed trays 39a and 39b, respectively, and the reference numeral 45 denotes another pair of carriage rollers, which are disposed between the gate unit 40 and the final transfer unit 43, for carrying the recording media 38.

A substantial configuration of the image forming system including the image forming apparatus 46 according to the present embodiment, the configuration of the printer controller (not illustrated in the drawings) provided in the image forming apparatus 46, and a processing flow when the image forming apparatus 46 receives the print data transmitted from the external information processing devices 13a, 13b . . . are substantially the same as those explained in the above-mentioned embodiment in FIG. 2, FIG. 3, and FIG. 4. Therefore, the repeated explanations thereof are omitted.

In the embodiments, when printing is performed in a state where the allowable delay time for receiving a print request is preset in the printer driver or the printer body, the printer controller of the image forming apparatus compares the content of the print request with the operating state of the printer engine unit, the allowable delay time for receiving the print job, and the absolute time (clock), and performs the printing operation continuously when the printer engine unit is in a operable state.

Furthermore, when the printer engine unit is in a standby state and there is time remaining by the printing delay time, the print request is temporarily held in the image forming apparatus. Therefore, it is possible to provide the image forming apparatus and the image forming system that are capable of reducing the power load and prolonging the lifetime of the consumables therein.

The present invention adopts the above-mentioned configuration, thereby enabling to reduce the power load of the printer engine unit in the image forming apparatus and to prolong the lifetime of consumables used in the printer engine unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a print data storing unit that stores therein input print data;
a delay-time input unit that inputs delay time for receiving a print of the print data;
a controlling unit that controls start timing of printing by referring to the delay time for receiving the print that has been input from the delay-time input unit, actual time, and a printing state; and
a printing unit that converts the print data stored in the print data storing unit into printing image data suitable for printing and starts printing.

2. The image forming apparatus according to claim 1, wherein the controlling unit is capable of resetting start timing of printing based on newly input print data.

3. The image forming apparatus according to claim 1, wherein
the image forming apparatus is connectable to an external information processing device, and
the print data is inputtable to the image forming apparatus from the external information processing device.

4. The image forming apparatus according to claim 3, wherein
the image forming apparatus is connectable to an external information processing device, and
the delay time for receiving the print is inputtable to the image forming apparatus also from the external information processing device.

5. An image forming system comprising:
an image forming apparatus that includes:
a print data storing unit that stores therein input print data;
a controlling unit that controls start timing of printing by referring to delay time for receiving a print, actual time, and a printing state; and
a printing unit that converts the print data stored in the print data storing unit into printing image data suitable for printing and starts printing; and
an external information processing device connected to the image controlling apparatus, wherein
the delay time for receiving the print is inputtable together with the print data to the image forming apparatus from the external information processing device.

6. The image forming system according to claim 5, wherein
the controlling unit is capable of resetting start timing of printing based on newly input print data.

7. The image forming system according to claim 5, wherein
a plurality of the external information processing devices are connected to the image forming apparatus.
